(19) United States
(12) Patent Application Publication
(10) Pub. No.: US 2020/0027339 A1
(43) Pub. Date: Jan. 23, 2020

(54) Method and System of Predictive Maintenance of a Textile Machine

(71) Applicant: Maschinenfabrik Rieter AG, Winterthur (CH)

(72) Inventors: Martin Gutberlet, Düsseldorf (DE); Nitin T. Patil, Pune (IN)

(21) Appl. No.: 16/336,328

(22) PCT Filed: Sep. 19, 2017
(86) PCT No.: PCT/IB2017/055649

§ 371 Date: Mar. 25, 2019

(30) Foreign Application Priority Data
Sep. 26, 2016 (CH) 01258/16

(51) Int. Cl. G08B 31/00; D01H 13/32; G08B 29/18

(52) U.S. Cl. CPC G08B 31/00; G08B 29/185; D01H 13/32

(57) ABSTRACT

A method and associated system are provided for predictive maintenance of a textile machine that has a plurality of sensors configured therewith. A reference value is defined for each sensor, and the reference values are stored in a data base. Each sensor is read during the operation of the textile machine and a signal from each sensor is correlated with the stored reference value for the sensor. An alert or warning is generated to an operator of the textile machine when the correlated signal from one or more of the sensors shows a data irregularity.

### FIELD OF THE INVENTION

A method and system of predictive maintenance of a textile machine, in particular pre-spinning or spinning machines, are provided having a plurality of sensors.

### BACKGROUND

In particular, this invention relates to a monitoring system for textile spinning machinery, for example blow room machines such as a bale plucker, mixer, pre and fine opener, blending machines, carding machines, spinning preparatory machines (for example a drawing frame, lap winder, comber or roving), and spinning machines (such as ring, compact, rotor and air jet spinning machines). As it is known, for a spinning line to be economically profitable, it must work continuously, without interruptions due to breakdown or processing stoppages.

However, the repair work necessary to restore the operation of a machine frequently leads to production downtime for a longer of shorter period, depending on the extent of the fault. It is therefore extremely important to intervene on the machines in time to perform service that is scheduled or guided by the monitoring system before a breakdown or fault occurs. This approach to maintenance management is known by the term “predictive maintenance”. However, effectively implementing a predictive maintenance system is extremely complex, since predictions of breakdowns or faults, based on which the service is to be performed, can be deemed reliable only if based on experience from a high number of cases, i.e., from a high number of machines, a high number of hours of work and a large historical archive of applications and operating conditions, well beyond the machines present in a single spinning mill.

Several patent applications in the field of monitoring textile machines are known. CH705443, for example, discloses a textile quality control system for use with a spinning or winding machine and a method for monitoring and controlling a textile quality control system.

U.S. Pat. No. 5,124,928 discloses a system that contains measurement elements associated with the workstations, and means for evaluating the signals supplied by the measurement elements, characteristic parameters being obtained during the evaluation for the individual workstations and analyzed for significant deviations from the corresponding desired values. The desired values are formed from the behavior of a statistically comparable collective. At the beginning of each monitoring operation, generalized start values are used for the individual desired values, which are converted during the course of the monitoring into more accurate, absolute values. These are updated continuously and form the core data for an automatic inference process. Consequently, the method of functioning of the system, which can be employed in particular in winding rooms for monitoring automatic spoolers, is automatic and objective, and the evaluation of the measurement results becomes independent of the interpretation of the operating personnel.

DE10142976A1 discloses a textile plant which has multi-position machines with travelling service units and their associated control and memory devices. Communication links, e.g. a data bus, are arranged to link the second service unit on a machine or service units on other machines to the first service unit to allow exchange of processing data between the various memory devices. Independent claims are also included for: transmission of processing parameters between travelling service units on one or more textile machines; a textile plant with central preparation and control of processing parameters referring to a particular production batch; and central preparation of multiple control parameters for a textile plant and transmission to the various control units.

WO2016016739 discloses another monitoring system of a spinning line which comprises detection devices associated to textile machines and main storage means, placed in a control room remote with respect to the spinning line and remote processing means operatively connected with the main storage means for processing a huge amount of data (Big Data), to implement a predictive maintenance. The disadvantage of this method and system is, however, that the correlation of data remains unclear.

### BRIEF SUMMARY OF THE INVENTION

A purpose of this invention is to provide a method and a system for monitoring the operation of textile machines in a spinning line for the implementation of a reliable predictive maintenance system.

Another purpose of the invention is to provide a method and a system for monitoring the operation of textile machines in a spinning line for the implementation of a reliable predictive maintenance system, which is self-learning.

Another purpose of the invention is to provide a method and a system for monitoring the operation of textile machines in a spinning line for the implementation of a reliable predictive maintenance system, which can read and handle a huge number of sensors.

Additional objects and advantages of the invention will be set forth in part in the following description, or may be obvious from the description, or may be learned through practice of the invention.

The purposes are achieved by a method and system as described and claimed herein.

According to a method embodiment of the invention, a method of predictive maintenance of a textile machine, which comprises a number of sensors, includes the steps:
a) defining a reference value for each sensor and storing the reference values in a data base;
b) reading each sensor during the operation of the textile machine;
c) correlating the signal of each sensor with the stored reference value; and
d) giving an alert or warning, if a correlated signal of a single or a plurality of sensor data show irregularities.

According to a system embodiment of the invention, a system of predictive maintenance of a textile machine, which comprises a number of sensors, includes:
a) a number of sensors that measure a respective physical quantity;
b) a data base with stored reference values for each sensor;
c) a system control for correlating the signal of each sensor with the stored reference value; and
d) a display for displaying an alarm to the operator of the textile machine, if a single sensor data and a correlated sensor data show irregularities.

The monitoring system allows effectively implementing a predictive maintenance and, through special calculation algorithms, allows notifying the maintenance operators of the need to perform preventive maintenance service, since it allows collecting, storing and analyzing a huge amount of data (Big Data, i.e., a collection of data so extensive in terms of volume, speed and variety as to require specific technologies and analytical methods for the extraction of value), coming from a large number of machines of a spinning line or multiple spinning lines.

Advantageously, moreover, the method and system according to the invention collecting and storing a large amount of data over very long periods of time, thereby allowing the detection of drift phenomena, or statistical phenomena, that are often symptoms of malfunctions or the slow deterioration of operating conditions, usually not recognizable or identifiable. Thus, advantageously, the monitoring system according to this invention allows activating an online support service by virtue of the remote detection of an anomalous trend, drift, a value, or any other anomaly.

Advantageously, the sensors are temperature, pressure, vibration, velocity, acceleration, current, voltage, optical, camera or force sensors which can be used and read out and deliver machinery data.

According to a further aspect, the method is advantageously self-learning by continuously correlating the signal of each sensor with the stored reference value and re-defining reference values for the sensors. The operator could additionally work on an alert and give a feedback, for example, which fault was existent and which maintenance was necessary. For this purpose, the textile machine comprises an input section in which an operator who works on an alarm can input a feedback on the maintenance. The machine takes in this information into account and is more effective in recognizing future maintenance needs.

According to a further advantageous embodiment, as a reference value for a sensor, a time stamp, a signature or a pattern could be used. When, as the reference value for a sensor a time stamp is used, different time stamps could differ in the time length.

The step of correlating the signal of each sensor with the stored reference value could advantageously be done in real-time. The step of correlating may include one or a plurality of:
correlating different sensors that measure the same physical quantity to each other;
correlating different sensors that measure different physical quantities to each other;
correlating sensors of different sections of the textile machine to each other;
correlating sensors of different textile machines to each other; and
correlating sensors of different textile plants to each other;

According to a further advantageous embodiment, a number of sensors of a textile machine or of a section of the textile machine could be concentrated at a hub. This aims to transmit a greater number of values of the sensors to the system control. The hub will not only concentrate the sensor data, but also amplifies the signal. Thus, not only can the number of sensors be increased, but also much longer cables can be used in comparison to prior art systems.

According to a further advantageous embodiment, the step of alarming the operator of the textile machine comprises the step of displaying an alarm on a display or a mobile display such as on an app on a mobile phone. It could even be displayed when faulty sensors based on the stored reference values are recognized.

According to the invention, the textile machine could be of one of blow room machines, such as a plucker, mixer, opener, mixing loader, scale loader of tuft blender bale plucker, mixer, pre- and fine opener, blending machines, carding machines, combing machines and spinning machines, etc.

### BRIEF DESCRIPTION OF DRAWINGS

The invention will be better understood with the aid of the description of an embodiment given by way of example an illustrated by the figures, in which:

FIG. 1 shows an overall view of a spinning line in a spinning mill.

### DETAILED DESCRIPTION OF THE INVENTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

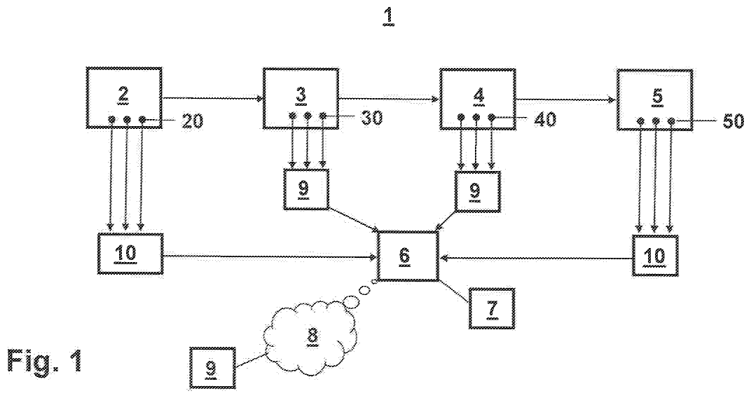

According to an embodiment of the invention, with reference to FIG. 1, a spinning line 1 is installed at a spinning mill. The term “spinning mill” refers to the industrial plant in which textile processes are carried out that consist in the sequence of operations necessary for the transformation of textile fibers such as cotton into yarn or thread. Preferably, a plurality of spinning lines 1 is installed in a spinning mill. The invention relates as well for spinning preparatory machines (for example a drawing frame, lap winder, comber or roving).

The spinning line 1 in FIG. 1 comprises, for example, one or more blow room machines 2 (such as bale plucker, mixer, pre- and fine opener, blending machines), one or more carding machines 3, combine machine 4, one or more spinning machines 5 (such as a ring, compact, rotor and air jet spinning machines), installed at the spinning mill, and a local apparatus 6 of a monitoring system, for the detection and/or collection of characteristic data of said machines 2, 3, 4, 5.

The system control 6 is connected to a plurality of sensors 20, 30, 40, 50 engaged with the respective machine 2, 3, 4, 5 for the detection of a plurality of physical quantities of the machine or machine parts or sections, such as an operating parameter. The number of sensors 20, 30, 40, 50 is shown only as an example and can dependent on the machine and the machine parts to be surveyed. During operations the sensors 20, 30, 40, 50 transmit their measured values to the system control 6 for analysis. Example for sensors 20, 30, 40, 50 in the present invention are sensors for temperature, pressure, vibration, velocity, acceleration, current, voltage, optical, camera or force or any other sensor, which could monitor the corresponding machine. The system control 6 further comprises processing means and a data storage 7 for storing reference values and measured values from the sensors. Furthermore, the system control 6 comprises a local processing means, for example a processor, operatively connected to the storage 7, for processing of the stored data.

According to a preferred embodiment, the monitoring system also could comprises local transmission/reception means, for example near field communication devices such as WLAN, Bluetooth, Zigbee, etc., operatively connected with the sensor 20 30, 40, 50 or groups of sensors in order to connect them with the hub 10 and/or with the system control 6.

In a first step of the inventive method of predictive maintenance of the spinning mill 1, or a single textile machine 2, 3, 4, 5 of the spinning mill, a reference value of each sensor is defined and stored in the data base 7. There are different possibilities for defining a reference values for sensors: a time stamp, a signature and/or a pattern. This value defines a “normal” measured value of a sensor over a time period. It is possible to directly take the measured signal as a time stamp or it would be possible to transfer the signal in order to come to a “signature” or “pattern” of the sensor. A transformation could be necessary in order to store the signal of a different sensor in the same way. Different sensors could also use different kind of reference values.

In a second step of the inventive method of predictive maintenance, each sensor is read out during the operation of the textile machine or transmits its value to the system control 6. The step could be done continuously or discontinuously at defined times. As seen in FIG. 1, a number of sensors of a textile machine, or of a section of the textile machine, can be concentrated via a hub 10 to the system control 6. This aims to transmit a greater number of values of the sensors 20, 30, 40, 50 to the system control 6. The hub 10 will not only concentrate the sensor data, but also amplifies the signal. Thus, not only the number of sensors be increased, but also much longer cables can be used in comparison to prior art systems.

In a third step of the inventive method of predictive maintenance, the signal of each sensor is correlated with the stored reference value of the sensor. The correlation step can be done in different possible ways:

a. Direct comparison with one or a variety of stored data values; this means that not a single value must be out of range, but even of a combination of sensors show irregularities, an alarm, alert or warning could be issued.

b. Data modeling of continued comparison of stored values with stored reference values. The reference values could as well be changed or adapted over time. This would include that the operator works on a given alarm, an alert, or warning and gives a feedback as to the kind of fault that existed and which maintenance was necessary. The method of predictive maintenance will thus be self-learning.

Correlation of the sensor values could include one or a combination of the following:
correlating different sensors measure the same physical quantity to each other;

As an example, temperature sensors would be correlated with temperature sensors; pressure sensors with pressure sensors, vibration sensors with vibration sensors, etc.
correlating different sensors that measure different physical quantities to each other;

As an example, sensors of different physical quantities, but on the same machine part, could be correlated to each other, e.g. temperature sensor with vibration sensor, or even with energy sensors.
correlating sensors of different sections of the textile machine to each other;

Different sections could e.g. include different motors or drives of a textile machine; spindles of a ring spinning machine; different drawing frames to each other, etc.
correlating sensors of different textile machines to each other;

Different textile machine could be correlated to each other, such as different drawing frames, carding machine, blow rooms, etc.
correlating sensors of different textile plants to each other;

It would even be possible that different locations of textile plants could be correlated to each other. To implement this embodiment of the invention, a central data base could be installed, where the data of a number of textile machines is stored and analyzed.

Finally, in a fourth step of the inventive method of predictive maintenance, an alert is given, if a correlated signal of a single or a plurality of sensor data show irregularities. The step of displaying can comprise giving an alert via a display of the system control or a mobile display 9, which is connected over a network 8 to the system control 6.

The monitoring system according to this invention allows effectively implementing a predictive maintenance and, through special calculation algorithms, allows notifying the maintenance operators of the need to perform preventive maintenance service, since it allows collecting, storing and analyzing a huge amount of data (Big Data, i.e., a collection of data so extensive in terms of volume, speed and variety as to require specific technologies and analytical methods for the extraction of value), coming from a large number of machines of a spinning line or multiple spinning lines.

Advantageously, moreover, the method and system according to the invention allow collecting and storing a large amount of data over very long periods of time, thereby allowing the detection of drift phenomena, or statistical phenomena, that are often symptoms of malfunctions or the slow deterioration of operating conditions, usually not recognizable or identifiable.

According to a further advantageous aspect, there is the possibility of collecting and storing various parameters of a machine, identifying correlations between them, for example between speed, current absorption and temperature. In addition, the system allows analyzing the data collected in the domain of frequencies for identifying periodic phenomena on a single parameter or a result of these correlations.

According to a still further advantageous aspect, the system allows identifying correlations between the performance of one or more parameters of a machine with those of a further machine, downstream or upstream of the preceding one, for example the trend of parameters of a carding machine or a blow room machine (upstream machine) with that of a spinning machine (downstream machine).

The architecture thus identified, given its flexibility, the possibility of accumulating large amounts of information and data (Big Data), and the ability to develop processing and calculation functions in a single central system that has available the historical trends of the operating parameters of the machinery, allows the gradual and continuous identification, development and evolution of correlation functionalities and prediction algorithms.

Purely by way of example, it is possible to correlate the trend of the quality of the carded tape in several carding machines as a function of the speed (for example, peripheral) of the drum or as a function of the ambient temperature over a calendar year.

Moreover, advantageously, the monitoring system according to this invention allows activating an online support service by virtue of the remote detection of an anomalous trend, drift, a value, or any other anomaly.

It is clear that one skilled in the art, in order to meet specific needs, may make changes to the monitoring system described above, all contained within the scope of protection defined by the following claims.

Advantageously, the monitoring system according to this invention allows activating an online support service by virtue of the remote detection of an anomalous trend, drift, a value or any other anomaly. According to a further advantageous aspect, the monitoring system according to this invention allows for remotely updating the management software of the machines, without the need for local intervention.

The invention as well is related to a computer program product, which comprises a software code portion, which can execute one or a plurality of the steps of the inventive method when it is stored and executed in an internal memory of the system control of a textile machine as described herein.

It is clear that one skilled in the art, in order to meet specific needs, may make changes to the monitoring system described above, all contained within the scope of protection defined by the following claims.

### REFERENCE NUMBERS

1 Spinning line

2 Blow room machine

20 Sensor related to blow room 2

3 Carding machine

30 Sensor related to carding machine 3

4 Combing machine

40 Sensor related to combing machine

5 Spinning machine

50 Sensor related to combing machine

6 System control

7 Data storage

8 Network

9 Display

10 Hub

1-24. (canceled)

25. A method of predictive maintenance of a textile machine that has a plurality of sensors configured therewith, the method comprising the steps
a) defining a reference value for each sensor and storing the reference values in a data base;
b) reading each sensor during the operation of the textile machine;
c) correlating a signal of each sensor with the stored reference value for the sensor; and
d) generating an alert or warning to an operator of the textile machine when the correlated signal from one or more of the sensors shows a data irregularity.

26. The method according to claim 25, wherein the sensors comprise a combination of one or more of following sensor types: temperature, pressure, vibration, velocity, acceleration, current, voltage, optical, camera, or force sensor.

27. The method according to claim 25, wherein the method is self-learning by continuously correlating the signal of each sensor with the stored reference value and re-defining the reference value for the sensors.

28. The method according to claim 25, further comprising receiving feedback from an operator who reacts to the alert, the feedback including a type of fault that generated the alert and maintenance performed as a result of the fault.

29. The method according to claim 25, wherein the reference value comprises one of a time stamp, a signature, or a pattern.

30. The method according to claim 25, wherein the reference value comprises a time stamp, wherein different time stamps have a different time length.

31. The method according to claim 25, wherein the signals from the sensors are correlated with the stored reference values in real-time.

32. The method according to claim 25, wherein the step of correlating comprises correlating different sensors that measure a same physical quantity to each other, or correlating different sensors that measure a different physical quantity to each other.

33. The method according to claim 25, wherein the step of correlating comprises correlating the sensors of different sections of the textile machine with each other, correlating the sensors of different textile machines with each other, or correlating the sensors of different textile plants with each other.

34. The method according to claim 25, wherein a plurality of the sensors of the textile machine or a plurality of the sensors of a section of the textile machine are connected to a hub.

35. The method according to claim 25, wherein the step of generating an alert or warning to the operator comprises giving instructions for maintenance to be done as a result of the data irregularity.

36. The method according to claim 25, wherein the step of generating an alert or warning to the operator comprises displaying an alarm on a display or a mobile display.

37. The method according to claim 25, further comprising determining faulty sensors based on the stored reference values.

38. A system for predictive maintenance of a textile machine, the system comprising:
a) a plurality of sensors configured with the textile machine, each of the sensors measuring a physical quantity;
b) a data base comprising a stored reference value for each sensor;
c) a control system configured to correlate a signal from each sensor with the stored reference value for the sensor; and
d) a display configured to present an alarm or warning to an operator of the textile machine when the correlated signal from one or more of the sensors shows a data irregularity.

39. The system according to claim 38, wherein the sensors comprise a combination of one or more of following sensor types: temperature, pressure, vibration, velocity, acceleration, current, voltage, optical, camera, or force sensor.

40. The system according to claim 38, wherein the textile machine comprises one of a bale plucker, mixer, pre or fine opener, blending machine, carding machine, combing machine, or spinning machine.

41. The system according to claim 38, further comprising an input section configured for the operator of the textile machine to input feedback including a type of fault that generated the alert and maintenance performed as a result of the fault.

42. The system according to claim 38, wherein reference value comprises one of a time stamp, a signature, or a pattern.

43. The system according to claim 38, wherein the reference value comprises a time stamp, wherein different time stamps have a different time length.

44. The system according to claim 38, wherein the display comprises a mobile display.

45. The system according to claim 38, wherein the control system is further configured to correlate different sensors that measure a same physical quantity to each other, or correlate different sensors that measure a different physical quantity to each other.

46. The system according to claim 38, wherein the control system is further configured to correlate he sensors of different sections of the textile machine with each other, correlate the sensors of different textile machines with each other, or correlate the sensors of different textile plants with each other.

47. The system according to claim 38, wherein a plurality of the sensors of the textile machine or a plurality of the sensors of a section of the textile machine are connected to a hub.
